(19) United States
(12) Patent Application Publication
(10) Pub. No.: US 2015/0120544 A1
(43) Pub. Date: Apr. 30, 2015

(54) Rapid credit card fraudulent use detection system and method

(71) Applicant: Sammy Black Marji, Yonkers, NY (US)

(72) Inventor: Sammy Black Marji, Yonkers, NY (US)

(21) Appl. No.: 13/998,349

(22) Filed: Oct. 24, 2013

(51) Int. Cl. G06Q 20/40; G06Q 20/34; G06Q 20/24

(52) U.S. Cl. CPC G06Q 20/4016; G06Q 20/24; G06Q 20/34
USPC 705/44

(57) ABSTRACT

A method and system provided for rapid detection of credit card transactions by a merchant and reporting the transaction to the credit card holder for confirming or denying the accuracy of said transaction and reporting such information or denial directly to the merchant.

### FIELD OF THE INVENTION

The present invention relates to a system and method for rapid detection of unauthorized use of credit cards and the prevention of such unauthorized transactions. The invention also relates to the rapid detection of fraudulent purchase made by using smart phones, tablets or computers to provide credit card information without the use of the credit card holder.

### BACKGROUND OF THE INVENTION

Millions of consumers in recent years have utilized credit cards, charge cards, debit cards and/or smart cards to purchase goods and services and to transact business with merchants. Millions of these consumers also enjoy the benefits of having bank accounts and conducting business with their bank by using such cards. While consumers have enjoyed the convenience of credit card transactions, their use of credit cards has not been free of disadvantages such as credit card theft. It is estimated that each year hundreds of millions are lost as a result of unauthorized or fraudulent use of credit cards by unauthorized individuals.

The surge in fraudulent use of credit cards as well as other cards has prompted many merchants, banks and credit card issuing institutions to develop systems and methods designed to detect such fraudulent use in an effort to minimize the losses which have been experienced in recent years. Several of these systems and methods have been described in recent patents and publications. For example, U.S. Pat. No. 7,752,135 B2 issued Jul. 6, 2010, and assigned on its face to International Business Machine, describes a system and method for preventing credit card fraud by comparing the location of a given transaction with the location of a predetermined communication device. See the flow chart in FIG. 3 and its corresponding description in the specification of the patent in column 8, lines 4-48.

Other patents and patent publications describing credit card fraud detection systems and methods include U.S. Pat. No. 8,145,561 B1 issued Mar. 27, 2013; Pub. No. US 2009/0112765A1 published Apr. 30, 2009; Pub. No. US 2009/0045351 A1 published Feb. 19, 2009; Pub. No. US 2008/0120190 A1 published May 22, 2008; U.S. Pat. No. 7,376,431 B2 issued May 20, 2008; U.S. Pat. No. 7,149,296 issued Dec. 12, 2006 and U.S. Pat. No. 5,627,886 issued May 6, 1997.

Notwithstanding the plethora of recent developments of systems and methods of detection of fraudulent use of credit cards, there is still a dire need for a system and method for more rapid and effective detection of unauthorized credit card use in order to protect credit card holders and to minimize the resulting losses.

It is therefore an object of this invention to provide a system and method of detecting fraudulent use of a credit card.

It is also an object of the present invention to provide a system and method for rapid detection of fraudulent use of credit card and reporting the fraudulent transaction to the credit card holder.

It is yet another object of this invention to provide a system and method for rapid detection of fraudulent use of credit cards by communicating such transaction to the credit card holder and rapid response from the credit card holder to the merchant regarding such transaction.

It is a further object of this invention to provide a system and method of rapid detection of unauthorized electronic purchases through the use of smart phones, tablets or computers and reporting such unauthorized use back to the merchant.

The foregoing and other objects of this invention will become apparent and more clearly understood from the following detailed description of the invention and its related drawings.

### BRIEF DESCRIPTION OF THE DRAWINGS

Referring to the drawings wherein like reference numerals designate like parts;

FIG. 1 is a flow chart illustrating the method steps taken in the present invention beginning with the presentation of the credit card to a merchant for a given transaction, and communicating the nature of such transaction back to the merchant.

FIG. 2 is a flow chart, partly in block, illustrating the method and system for rapid detection of fraudulent use of credit card transaction, reporting the transaction to the service provider and then to the credit card holder who can email or text his/her confirmation or denial of the transaction to the merchant.

### SUMMARY OF THE INVENTION

In accordance with this invention when a credit card is presented to a merchant for a transaction, the merchant swipes the card through a card reading device which sends out a text or email to the service card provider The service card provider, by its computer, verifies the account information and communication device and sends a text or email to the card holder. With knowledge of such communication, the card holder notifies the service provider by text or email, confirming or denying the transaction and the service provider can by its computer notify such denial or confirmation by texting or emailing the response to the merchant so that the merchant can approve or reject the transaction.

Alternatively, a consumer can make electronic purchases through a smart phone, tablet or computer wherein the consumer enters the credit card information on the merchant's website and the information is then sent to the service card provider who in turn sends a text or email to the card holder for confirmation or denial of said electronic transaction and wherein the credit card holder texts or emails confirmation or denial of the transaction directly to the merchant.

### DETAILED DESCRIPTION OF THE INVENTION

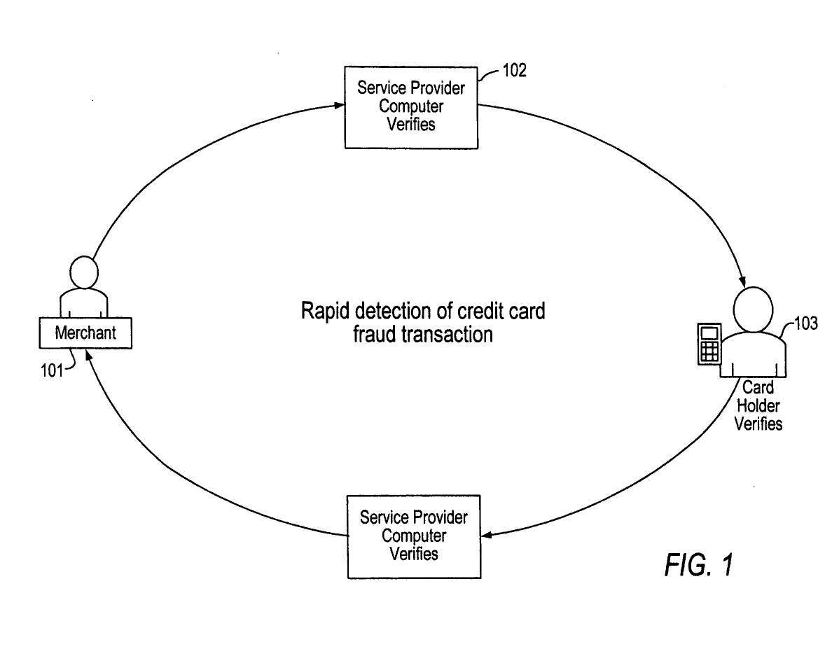

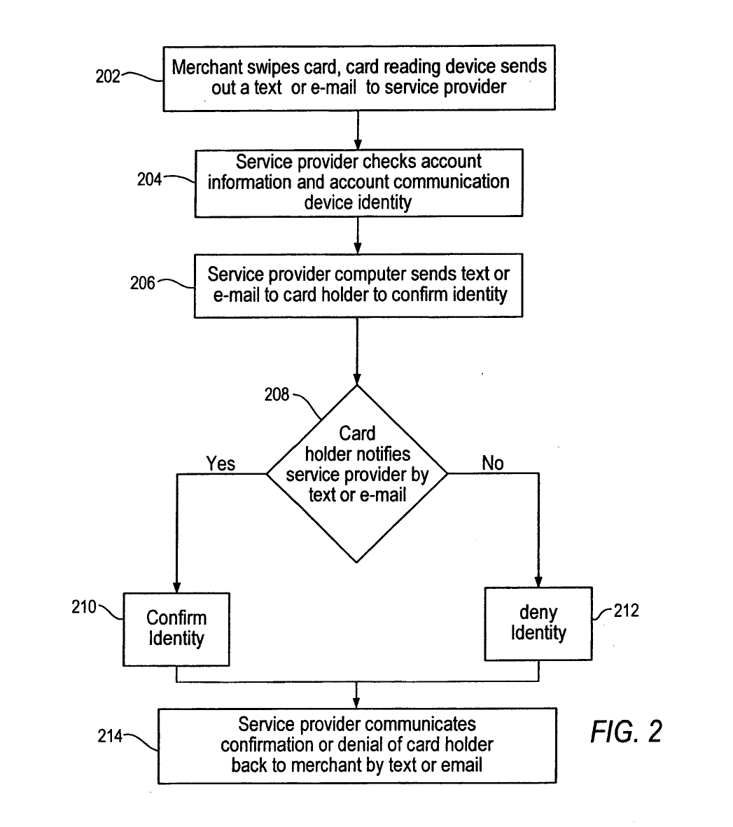

Referring to FIGS. 1 and 2, the user of the card (credit or debit) presents the card to a merchant 101 who swipes the card through a card reading device to enter the transaction amount. When the card is swiped through the card reading device, the card reading device is activated and sends a text or email to the service provider, step 202 in FIG. 2. The service provider may be a credit card company, a bank or any other financial or credit card institution familiar to the credit card holder or the financial institution. Once the service provider receives the information about the amount of transaction, it verifies the account information relating to the transaction, step 203 in FIG. 2, by its computer 102, and then sends a text or email to the credit card holder 103, step 206 in FIG. 2.

The card reader and the computer used in the method of this invention are generally known in the art and are described in several prior art patents some of which were mentioned hereinbefore in this specification. After the service provider computer 102 sends a text or email to the card holder to confirm or deny the transaction, the card holder notifies the service provider by text or email whether or not to confirm or deny the transaction, see step 208 in FIG. 2. The card holders instruction to confirm or deny the transaction is communicated by text or email directly in step 210 or step 212, see FIG. 2, to the service provider who will communicate the information directly back to the merchant, step 214, FIG. 2, by means of computer 104.

In another embodiment of this invention, an unauthorized consumer can make a transaction electronically using a smart phone, tablet or computer. Thus, an unscrupulous consumer who may have obtained the card holder information without permission or authority by the credit card holder enters the credit card information on the merchant website by using a smart phone, tablet or computer. This information is then sent to the service card provider who in turn will transmit the information by text or email to the card holder for confirmation or denial of the electronic transaction. As it can be appreciated, the method and system employed in this embodiment are essentially the same as described in connection with FIGS. 1 and 2.

Other methods and systems for the detection of unauthorized use of credit card or information provided to a merchant will be obvious from the foregoing detailed description of the invention.

1. A method of rapid detection of credit card transaction and reporting the transaction to the card holder, which method comprises:
(a) presenting a credit card to a merchant for a transaction and swiping said card through a credit card reading device by said merchant;
(b) texting or emailing said information relating to said transaction received from said credit card reading device to a credit card service provider;
(c) verifying said information by said credit card provider and an associated computer and communicating said information by texting or emailing to the credit card holder by means of said computer;
(d) confirming or denying accuracy of said information by said credit card holder, and
(e) texting or emailing confirmation or denial of said information relating to said transaction from said credit card holder directly to said merchant.

2. A method of rapid detection of electronic transaction such as purchase of goods which method comprises:
(a) entering credit card information on a merchant's website by electronic means;
(b) texting or email said information by said merchant to a credit card service provider;
(c) verifying said information by said credit card provider and an associated computer and communicating said information by texting or emailing to the credit card holder by means of said computer;
(d) confirming or denying accuracy of said information by said credit card holder, and
(e) texting or emailing confirmation or denial of said information relating to said transaction from said credit card holder directly to said merchant.
